(19) United States
(12) Patent Application Publication
(10) Pub. No.: US 2024/0167946 A1
(43) Pub. Date: May 23, 2024

(54) SENSOR DEVICE AND SENSOR ARRANGEMENT

(71) Applicant: AMS SENSORS GERMANY GMBH, Jena (DE)

(72) Inventors: Remco VERDOOLD, Geldrop (NL); Erik Jan LOUS, Veldhoven (NL)

(21) Appl. No.: 18/276,672

(22) PCT Filed: Jan. 27, 2022
(86) PCT No.: PCT/EP2022/051915

§ 371 Date: Aug. 10, 2023

(30) Foreign Application Priority Data
Feb. 11, 2021 (DE) 10 2021 103 211.3

(51) Int. Cl. G01N 21/35

(52) U.S. Cl. CPC G01N 21/35; G01N 2201/0636

(57) ABSTRACT

A sensor device includes a light source configured to emit a primary radiation, a detector having a plurality of detector units, and a sensor film including metallic nanoparticles geometrically between the reflecting optical element and the detector. The sensor film is configured to be exposed to a liquid or gas. The detector is configured to detect a spectral change in the primary radiation caused by the sensor film upon exposure to the liquid or gas. The reflecting optical element is a parabolic mirror. The reflecting optical element is the only reflective optics in a beam path between the light source and the detector. The detector is configured to detect secondary radiation scattered by the metallic nanoparticles. The primary radiation from the light source scattered at the metallic nanoparticles is measured in a transmission configuration.

A sensor device is provided. Further, a sensor arrangement comprising such a sensor device is also provided.

An object to be achieved is to provide a compact sensor device having a high sensitivity to constituents of a liquid or gas.

This object is achieved, inter alia, by a sensor device and by a sensor arrangement as defined in the independent patent claims. Further preferred developments constitute the subject-matter of the dependent claims.

In particular, the sensor device comprises a light source which illuminate a detector by means of a mirror, wherein metallic nanoparticles are applied onto a sensor film, or the light source is located directly above the sensor film. The detector is configured to measure spectral changes due to adhesion of molecules on the metallic nanoparticles, wherein light from the light source and scattered at the metallic nanoparticles is measured in a transmission configuration.

Hence, no bulky optics with a prism and with lenses are required and miniaturization of the sensor device is possible so that no table top solution is necessary. Accordingly, there are no prism de-alignment risks, and the sensor device is particularly cost-efficient. Further, a gold layer as a sensor film can be replaced by gold nanoparticles, GNP for short, so that techniques like physical vapor deposition, PVD for short, which are not compatible with typical silicon processing technologies, can be avoided.

In at least one embodiment, the sensor device comprises a light source configured to emit primary radiation, a detector comprising a plurality of detector units, and a sensor film comprising metallic nanoparticles geometrically between the reflecting optical element and the detector. The sensor film is configured to be exposed to a liquid or gas. Further, the detector is configured to detect a spectral change in the primary radiation caused by the sensor film upon exposure to the liquid or gas. Thus, constituents of the liquid or the gas can be measured with high accuracy.

According to at least one embodiment, the light source is a semiconductor light source. It is possible that the light source is a narrowband or a broadband source. Broad may mean that a full width at half maximum of an emission spectrum is at least 5 nm or at least 10 nm or at least 30 nm, and may optionally be at most 100 nm or at most 50 nm. Narrowband may mean that the full width at half maximum of the emission spectrum is at most 4 nm or at most 1 nm. If a broadband light source is required, a plurality of narrowband sub-light sources having different peak emission wavelengths can be combined. It is also possible that there is more than one sub-light source of the same type to constitute the light source. The light source, or the sub-light sources, can be configured to be operated in a continuous wave, cw for short, or pulsed mode or modulated mode with, for example, a sine wave or a block wave.

According to at least one embodiment, the detector is a semiconductor detector like a photo diode or a camera. The photo diode can be pixelated to shape the detector units. For example, there are at least eight or at least 16 detector units and/or at most 2×10⁴ or at most 1×10³ or at most 1×10² detector units. All the detector units can be of the same configuration, that is, of the same material and/or size and/or sensitivity, or there are differently fashioned detector units.

According to at least one embodiment, the sensor device further comprises a reflecting optical element. The reflecting optical element is optically arranged between the light source and the detector.

According to at least one embodiment, the reflecting optical element is a specularly reflecting mirror like a metal mirror or a Bragg mirror. Otherwise, the reflecting optical element is a diffusely reflecting surface like a white plastic or a white ceramic.

That the reflecting optical element is optically between the light source and the detector can mean that the primary radiation from the light source arrives at the detector only or predominantly upon reflection at the reflecting optical element. For example, at least 95% or at least 99% of the radiation arriving at the detector has been reflected at the reflecting optical element. It is not necessary that there is a straight connection line between the light source and the detector which intersects the reflecting optical element.

That the sensor film is located geometrically between the reflecting optical element and the detector may mean that there is at least one straight connection line between the reflecting optical element and the detector intersecting the sensor film. Preferably, all of the sensor film is located geometrically between the reflecting optical element and the detector. In this case, the sensor film is also optically located between the reflecting optical element and the detector.

According to at least one embodiment, the light source is located above the sensor film. This may mean that, seen in top view of the sensor film, the light source is directly above the sensor film. Alternatively or additionally, this may mean that a main emission direction of the light source points to the sensor film, in particular directly to the sensor film. For example, the main emission direction is that direction along which the highest intensity is irradiated by the light source.

The sensor film may comprise only one type or different types of metallic nanoparticles. The types of nanoparticles may differ in mean size, surface activation, material and/or size distribution.

Although the sensor film may be configured to be exposed to a liquid or gas, preferably the sensor device is configured as a gas sensor like an electronic nose. Hence, the sensor device may be configured for gas only.

The spectral change in the primary radiation caused by the sensor film upon exposure to the liquid or gas may be at least one of a spectral shift and an intensity change. The intensity change can be negative, that is, the nanoparticles absorb the primary radiation, as well as positive, that is, there is fluorescence or phosphorescence. It is possible that there are first spectral regions with a negative intensity change as well as second spectral regions with a positive intensity change.

According to at least one embodiment, the reflecting optical element is a parabolic mirror, in particular a specularly reflecting parabolic mirror. That is, the reflecting optical element may be part of a paraboloid of revolution and/or may have at least one parabolic reflective surface when seen in cross-section. It is possible that the reflecting optical element is parabolic along only one direction and is free of any curvature along another, perpendicular direction.

According to at least one embodiment, the reflecting optical element is the only reflective optics in a beam path between the light source and the detector. Hence, in this configuration there is only one mirror, that is, the reflecting optical element, optically between the light source and the detector. In other configurations, there may be a plurality of mirrors and/or reflecting optical elements optically between the light source and the detector.

According to at least one embodiment, the detector is configured to detect secondary radiation scattered by the metallic nanoparticles. The secondary radiation may be part of the primary radiation, or may be radiation stemming from the primary radiation, for example, due to fluorescence or phosphorescence. Preferably, the secondary radiation is only or predominantly such radiation that has interacted with the nanoparticles. Predominantly may mean a proportion of at least 90% or at least 95% or at least 99% or at least 99.8%. In particular, the detector is configured to detect only the secondary radiation and no other radiation.

According to at least one embodiment, at least some of the detector units are assigned to different kinds of metallic nanoparticles. Optionally, the different kinds of metallic nanoparticles may comprise different receptor shells, so that the detector is sensitive to one or to a plurality of constituents of the liquid or gas to be detected.

For example, possible receptor shells are disclosed in document US 2020/0256793 A1 or in document Sophie Brenet et al., “Highly-Selective Optoelectronic Nose Based on Surface Plasmon Resonance Imaging for Sensing Volatile Organic Compounds”, Anal. Chem. 2018, 90, 16, 9879-9887, Jul. 19, 2018, https://doi.org/10.1021/acs.analchem.8b02036.

According to at least one embodiment, at least some of the detector units are assigned to different wavelength regions. In other words, at least some of the detector units are sensitive in different spectral regions. Hence, by sampling the signal from different detector unis, a spectrum, or part of a spectrum, of the secondary radiation can be measured. In a first configuration, there is only one detector unit per wavelength region, or in a second configuration, there is a plurality of detector units for at least some or for all of the wavelength regions. The measured spectrum may be a continuous spectrum, or may be composed of only a couple of reference points at distant wavelength regions. In other words, not the full spectrum of the secondary radiation needs to be measured, but key or fingerprint wavelength regions may suffice.

As an alternative, the detector units are assigned to only one wavelength region, whereas there can be additional detector units to measure an ambient or background brightness.

According to at least one embodiment, the sensor device further comprises spectral filters assigned to the detector units. By means of the spectral filters, the wavelength regions can be defined. The spectral filters can be Bragg filters or material filters. The filters may work in absorption mode or in reflection mode.

According to at least one embodiment, the spectral filters each have a spectral transmission window with a full width at half maximum of at most 10 nm or of at most 5 nm. For example, said spectral transmission windows have a width of at least 1 nm and/or of at most 4 nm.

According to at least one embodiment, at least one or at least some or all of the transmission windows are located on a long-wavelength wing of extinction spectra of the metallic nanoparticles. In other words, the at least one respective transmission window is located on a ‘red’ slope of the respective spectral band of the secondary radiation.

According to at least one embodiment, the sensor device further includes a pair of polarizers comprising a first polarizer and a second polarizer. By means of the polarizers it is possible that only the secondary radiation reaches the detector.

According to at least one embodiment, the sensor film is arranged between the first polarizer and the second polarizer. Hence, all of the primary radiation not interacting with the nanoparticles does not undergo any change in polarization and can consequently be discriminated by means of the polarizers which can be arranged in a crossed manner, that is, with transmission polarization direction perpendicular to each other.

According to at least one embodiment, the first polarizer is located between the reflecting optical element and the sensor film. The second polarizer may be located between the sensor film and the detector.

According to at least one embodiment, the first polarizer and the sensor film define a channel through which the liquid or gas is led across the sensor film. Thus, the liquid or gas may be kept away from the reflecting optical element, and by means of the first polarizer a gas flow can be well-defined.

According to at least one embodiment, a distance between the sensor film and the first polarizer is at least 0.2 mm or at least 0.4 mm or at least 1 mm or at least 4 mm. Alternatively or additionally, said distance is most 5 mm or at most 1 mm.

According to at least one embodiment, seen in top view of the detector), the metallic nanoparticles are applied only atop the detector units so that an intermediate space between adjacent detector units is free of the metallic nanoparticles. By doing so, optical cross-talk between adjacent detector units can be reduced or avoided.

According to at least one embodiment, seen in top view of the detector units, an area proportion of the respective detector unit covered by the assigned metallic nanoparticles is at least 0.01 or at least 0.05. Alternatively or additionally, said proportion is at most 0.3 or at most 0.2 or at most 0.1 of an overall area of the respective detector unit, seen in top view. In other words, the nanoparticles themselves cover only a relatively small portion of the assigned detector unit, seen in top view. By doing so, undesired interactions between adjacent nanoparticles can be reduced or avoided.

According to at least one embodiment, the metallic nanoparticles are of bi-pyramidal shape. Otherwise, the nanoparticles can also be of pyramidal, prismatic, cylindrical, conical, ellipsoidal or spherical shape. However, a bi-pyramidal shape is preferred.

According to at least one embodiment, the nanoparticles have an aspect ratio of a mean length to a mean width of at least 2 and of at most 8, for example, of at least 3 and of at most 6.

According to at least one embodiment, the mean length is at least 0.04 μm or at least 0.1 μm. Alternatively or additionally, said mean length is at most 0.5 μm or at most 0.2 μm.

According to at least one embodiment, at least 90% or at least 95% of the metallic nanoparticles have a length of at least 0.7 times and of at most 1.5 times the mean length. In other words, a length distribution of the nanoparticles is comparably narrow.

According to at least one embodiment, the light source is a light-emitting diode or a semiconductor laser or comprises at least one light-emitting diode or at least one semiconductor laser.

According to at least one embodiment, the primary radiation is near-infrared radiation. For example, a peak wavelength of the primary radiation is at least 750 nm and/or at most 1.2 μm. Otherwise, the primary radiation can also be visible light, mid-infrared radiation or near-ultraviolet radiation.

According to at least one embodiment, the metallic nanoparticles are of gold or contain gold.

According to at least one embodiment, seen in top view of a top side of the detector, a size of the detector is a least 0.3×0.3 mm² and/or at most 3×3 mm² or at most 10×10 mm². Hence, the detector is comparably small, seen in top view.

According to at least one embodiment, a height of the reflecting optical element above the top side of the detector is at most 1 cm or at most 1 mm or at most 0.5 mm. Hence, the sensor device can be comparably flat.

A sensor arrangement comprising such a sensor device is additionally provided. Features of the sensor arrangement are therefore also disclosed for the sensor device and vice versa.

In at least one embodiment, the sensor arrangement comprises one or a plurality of sensor devices. Moreover, the sensor arrangement comprises at least one evaluation unit configured to evaluate a signal from the detector.

According to at least one embodiment, the evaluation unit is on a main board and at least the sensor film is located on a separate daughter board. It is possible that all of the sensor device is located on the daughter board. Hence, the sensor film and/or the sensor device and/or the separate daughter board may be replaceable and/or disposable components of the sensor arrangement. Hence, for example, relatively short-living sensor films may easily be replaced with new sensor films, if required.

According to at least one embodiment, the main board and the daughter board are electrically connected by a connector. For example, a connection direction to connect the daughter board with the main board runs in parallel with the main board and the daughter board. Hence, a space-saving arrangement can be realized.

A sensor device and a sensor arrangement described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

In the Figures:

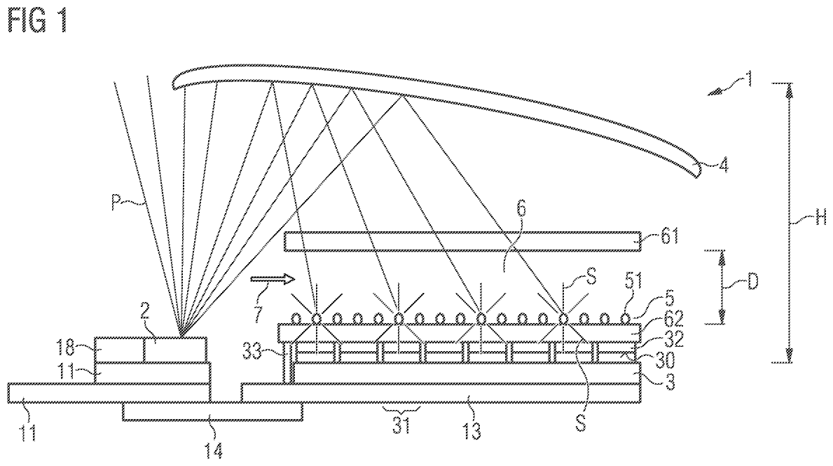

FIG. 1 shows a schematic sectional view of an exemplary embodiment of a sensor device described herein,

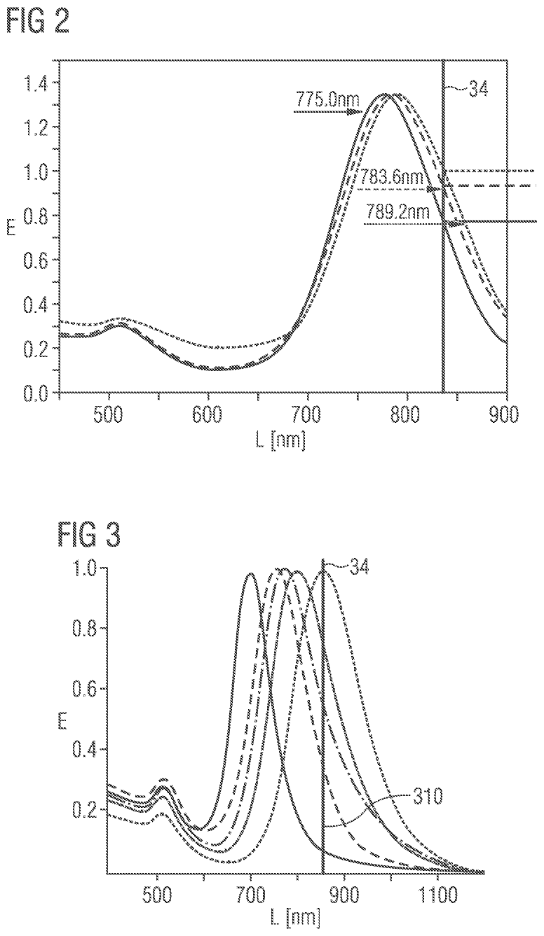

FIGS. 2 and 3 show schematic extinction spectra of metallic nanoparticles for exemplary embodiments of sensor devices and sensor apparatuses described herein,

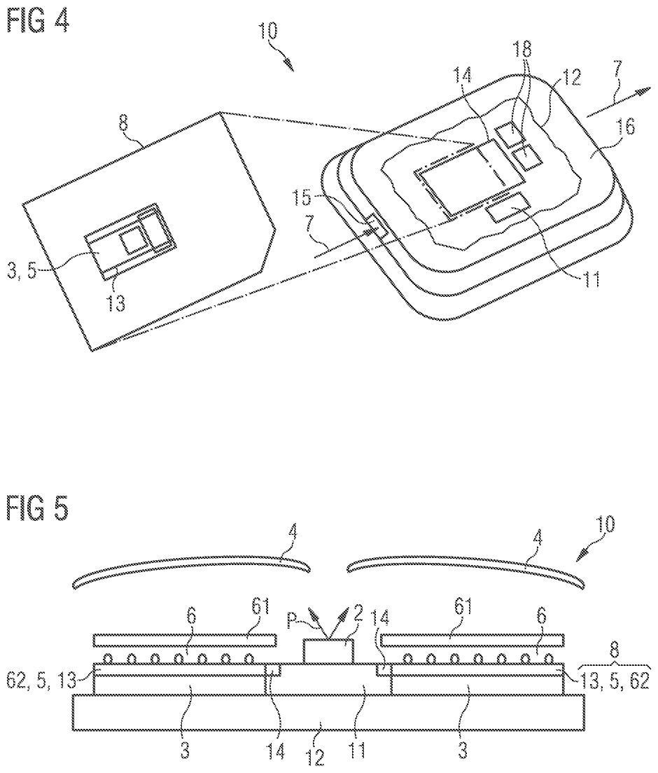

FIG. 4 shows a schematic perspective view of an exemplary embodiment of a sensor apparatus described herein,

FIGS. 5 to 7 show schematic sectional views of exemplary embodiments of sensor apparatuses described herein,

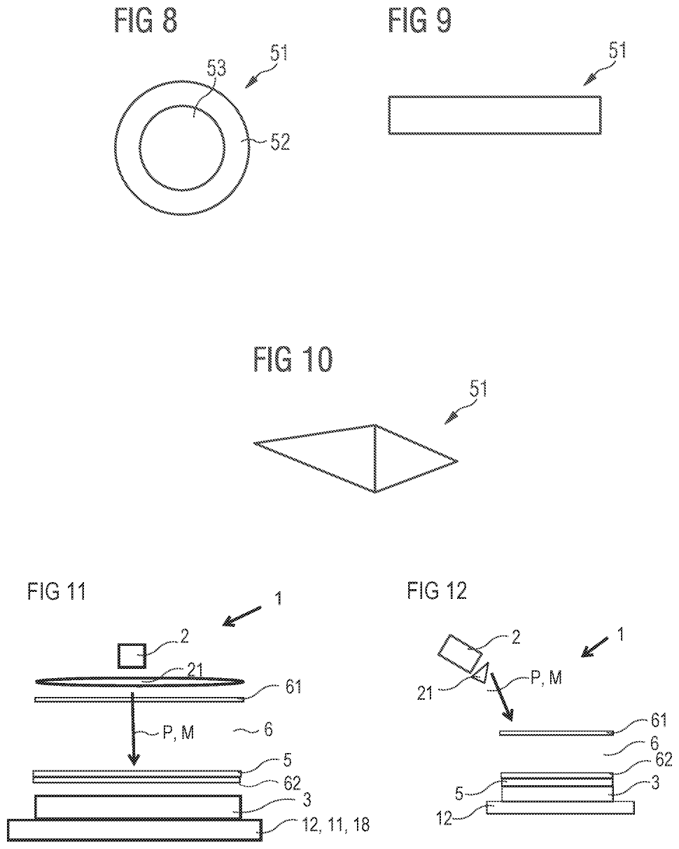

FIGS. 8 to 10 show schematic sectional views of metallic nanoparticles for exemplary embodiments of sensor devices and sensor apparatuses described herein, and

FIGS. 11 and 12 shows schematic sectional views of exemplary embodiments of sensor devices described herein.

In FIG. 1, an exemplary embodiment of a sensor device 1 is illustrated. The sensor device 1 comprises a light source 2 which is, for example, a light-emitting diode, LED for short. The light source 2 may emit red to near-infrared primary radiation P. The primary radiation P is emitted towards a reflecting optical element 4 of the sensor device 1 so that all or most of the primary radiation P reaches the reflecting optical element 4.

The reflecting optical element 4 is, seen in cross-section, of parabolic shape so that the primary radiation P from the point-like light source 2, which is preferably located in or near a focal point of the reflecting optical element 4, is parallelized to some degree. Hence, the primary radiation P impinges on a sensor film 5 of the sensor device 1 with a not too large angular distribution, and the sensor film 5 may be illuminated in a homogeneous manner. For example, the reflecting optical element 4 is a metallic mirror.

The sensor film 5 is arranged between the reflecting optical element 4 and a semiconductor detector 3 comprising a plurality of detector units 31, for example, 64 of the detector units 31.

Moreover, the sensor film 5 comprises a plurality of metallic nanoparticles 51, for example, gold nanoparticles. The nanoparticles 51 may be located on a carrier of the sensor film 5 or, as illustrated in FIG. 1, directly on a second polarizer 62. A first polarizer 61 is arranged between the sensor film 5 and the reflecting optical element 4 so that a channel 6 for a gas or a liquid to be detected is formed. The polarizers 61, 62 are arranged with polarization directions perpendicular to one another so that a part of the primary radiation P that does not change polarity upon interaction with the sensor film 5 cannot reach the detector.

The metallic nanoparticles 51 are provided with a shell, not shown in FIG. 1, so that the metallic nanoparticles 51 can adsorb specific molecules of the liquid or gas 7 that is led though the channel 6, indicated by an arrow. A distance D between the sensor film 5 and the first polarizer 61 is, for example, in the range of 0.1 mm to 1 mm.

When said molecules are absorbed, a spectrum of the radiation interacting with the metallic nanoparticles 51 is changed. In particular, a polarization direction is changed so that this part of the radiation, which is referred to as secondary radiation S, can pass the second polarizer 62 and can be detected in the detector units 31.

To allow a spectral sensitivity, spectral filters 32 are applied on the detector units 31. For example, the spectral filters 32 can be applied directly on the detector units 31, and the second polarizer 62 can be applied directly on the spectral filters 32.

The detector 3 may be pixelated so that a top side 30 of the detector 30 is optionally formed by a couple of elevations, each elevation may be assigned to exactly one detector unit 31.

Because of the use of the parabolic reflecting optical element 4, the sensor device 1 can be kept flat. For example, a height H of the reflecting optical element 4 above the top side 30 is in the range from 0.1 cm to 1 cm.

As an option, there is an optical insulation 33 between the detector 3 and the light source 2. Such optical insulations 33 may also be located between adjacent detector units 31, not shown in FIG. 1.

As a further option, the sensor film 5 and, if desired, also the detector 3 and/or the reflecting optical element 4, is arranged on a daughter board 13. The daughter board 13 may be connected to a main board 12 carrying the light source 2 by means of a connector 14 in a plug-in manner.

The main board 12 may carry an evaluation unit 11 to evaluate a signal of the detector 3 and to provide information about, for example, a gas concentration of at least one specific gas to be detected. Moreover, at least one environmental sensor 18, such as a temperature sensor and a humidity sensor, in order to correct for relative humidity dependencies, and/or a pressure sensor, to measure a gas flow, may be located on the main board 12, too.

In the following, the concept of using surface plasmons for detecting molecules in a gas, as used in the sensor device 1 described herein, is explained in more detail.

In principle, there are various techniques that are able to report or visualize the specific interaction between biomolecules. Such a technique or test may be referred to as a molecular interaction assay, which is arranged to measure the presence or concentration of a specific target molecule, which may be referred to as an analyte. A molecular interaction assay typically uses a bio-receptor which can bind to the analyte. Such interactions are extremely specific with the bio-receptor and analyte binding in a similar way to a key and a lock. Typically, only the correct analyte is able to bind to the bio-receptor.

Many such assays require also the use of a reporter molecule. The reporter molecule is operable to bind to the analyte, typically only once the analyte has bound to the bio-receptor. The reporter molecule can report the presence of the analyte target molecule in some way. For example, the reporter molecule may use: an enzyme, as in an enzyme linked immunosorbent assay, ELISA for short; radioactivity, as in a radio immunosorbent assay, RIA for short; or, more commonly, a fluorophore, as in a fluorescent immunosorbent assay, FIA for short.

As an alternative to the usage of reporter molecules, label-free detection assay methods have been developed and are gaining popularity. One label-free detection method is surface plasmon resonance, SPR for short.

One arrangement for using surface plasmon resonance as a label-free detection method, which may be referred to as a surface plasmon resonance apparatus, comprises a prism which is provided with a relatively thin layer of metal, for example, of gold, on a surface thereof. Electromagnetic radiation is coupled into the prism and is incident on the interface between the prism and the metal such that total internal reflection occurs. This generates an evanescent wave in the metal layer which propagates parallel to the interface between the prism and the metal and has an amplitude that decays exponentially in a direction perpendicular to the interface between the prism and the metal.

At the interface between the metal layer and an adjacent medium, surface plasmon polaritons can be generated. Surface plasmon polaritons are a type of coupled oscillation of electrons within the metal layer and an electromagnetic oscillation in the dielectric medium. In particular, surface plasmons are collective conduction electron oscillations at the interface of two layers, one layer being a metal and the second layer being a dielectric. If a thickness of the metal layer is sufficiently thin, with respect to a penetration depth of the evanescent wave, and a resonance condition is met, an evanescent wave can excite surface plasmon polaritons on an opposite side of the metal layer. This uses some of the energy from the incident electromagnetic radiation and therefore reduces the intensity of the electromagnetic radiation reflected from the interface between the prism and the metal layer.

Reflected electromagnetic radiation is coupled out of the prism and is incident on a detector, which is arranged to determine an intensity of the reflected electromagnetic radiation which, in turn, is dependent on whether or not surface plasmon polaritons have been excited.

The resonance condition is dependent on the wavelength and angle of incidence of the incident electromagnetic radiation. The resonance condition is also dependent on optical properties of both the metal and the adjacent dielectric medium. If the metal is provided with a bio-receptor on its surface, then these optical properties and therefore the resonance condition may vary in dependence on the presence or absence of a specific target molecule being bound to the bio-receptor. Therefore, by measuring information related to the resonance condition, it is possible to determine information about the presence and/or quantity of the specific target molecule adjacent the metal layer.

In some systems, a plurality of different bio-receptors are provided on the metal layer; each one is irradiated with electromagnetic radiation and the electromagnetic radiation reflected from each is detected by a separate detector. Such an arrangement is known as imaging SPR, iSPR for short, and this concept can be used in the sensor device 1 described herein, too.

One challenge with the above-described imaging surface plasmon resonance apparatus is that the resonance condition is very narrow and therefore it is important to have adequate control over the wavelength and angle of incidence of the incident electromagnetic radiation. In particular, one of the main design challenges in the above-described imaging surface plasmon resonance apparatus is the optical system. Typically, many lenses are required to project light properly onto the prism and to observe the reflected light on the imaging sensor. Each lens has a specific aligned optical path and focal distance to achieve the best illumination and image quality. In particular, the optics which illuminate the metal layer may be required to do so with a precision of the order of 0.1° in order to operate correctly.

With the sensor device 1 described herein, an apparatus for determining the presence or concentration of target molecules can be provided, and the sensor device 1 is much more compact than a prism set-up and requires much less precision.

For SPR in a prism apparatus, the change of the incident angle is measured at which an SPR-dip occurs. As stated previously, prism apparatuses are able to measure angular changes of about 0.005 degrees corresponding to a refractive index unit, RIU, resolution of about 7×10⁻⁵. As an intensity of light is measured, the camera or photodiode analogue-to-digital converter resolution has a major impact on the final RIU resolution. 16-bit analogue-to-digital converters has improved sensitivity to about 1×10⁻⁶.

There are two approaches for measuring the interaction. One is angle scanning measurement, determining the actual angular shift, or at a fixed angle measuring the change of intensity. For nanoparticles, as used in the sensor device 1, the RIU is expressed differently, whereas for SPR it is a measurement of angle, for nanoparticles it is a change in resonance frequency or Amax in nanometers. For spherical gold particles, for example, there is a 45 nm peak shift to red per RIU. This means that if the nanoparticle is exposed to a netto refractive index change of 1 unit, the Amax will shift with 45 nm.

Like in SPR, there are two changes that can be measured: the change in Amax itself or the increase of signal at the expected Amax. The precise measurement of Amax shift in nm is very difficult as a required sensitivity is usually 0.1 nm resolution. However, measuring an intensity increase at a very well determined, for example, spectral filter defined wavelength is very sensitive at high-resolution analoge-to-digital photodiodes with 16 bits or more. A local surface plasmon resonance, LSPR, RIU is mostly depending on the shape of the particle. In general, the higher the asymmetry the higher the RIU.

The nanoparticle scattering local surface plasmon resonance sensor device 1 described herein comprises multiple components, as explained in connection with FIG. 1. Some components are essential for LSPR measurements, other components are essential only for gas-phase measurements for an electronic nose, for example. For gas-phase applications, it is important to know the relative humidity, temperature and air pressure of the environment as all these variables interfere with the odor molecule interaction on the nanoparticle surface.

The flow channel 6, also referred to as air-duct, should include these type of sensors to obtain accurate information regarding binding. The air sample containing the odor molecules can be forced into the flow channel 6 by a using a pump, not shown, alternatively it could be designed in such a manner that air diffusion is sufficient to trigger the nanoparticles. Diffusion will be slower, but eliminates the need of an active element.

Thus, according to the exemplary embodiment shown in FIG. 1, light is emitted from the light source 2 upwards and the beam is broadened through the reflecting optical element 4 which is a curved mirror. The first polarizer 61 serves to maintain a single polarization. The polarization direction can be chosen such that the nanoparticles 51 are optimally illuminated to scatter the primary radiation P. Additionally, if a synthetic plasmonic generator is made, like a nano-antenna or a meta-material structure, the polarization can be fully optimized for this purpose.

Underneath the nanoparticles 51, the second, for example, identical polarizer 62 is placed to prevent any illuminating light getting onto the detector 3 as the light sensor. Additionally, the environmental sensor 18 is present for monitoring temperature, relative humidity and air pressure, for example. That is, the broadband light source 2 illuminates the nanoparticles 1 via the reflecting optical element 4, and the illumination results in the scattering of the nanoparticles 51. Upon specific binding of molecules, the scattering wavelength of the nanoparticles 51 shifts to longer wavelengths.

As mentioned above, all the detector units 31 can be sensitive in the same spectral region, or the detector units 31, or groups of detector units 31, are configured for different spectral regions.

FIG. 2 shows an example LSPR absorption spectrum C1 for gold nanorods, having a maximum, resonance wavelength of 775 nm. A transmission window of a 840 nm spectral filter 32 having a full width at half maximum, FWHM, of 5 nm is represented by line 34. If the absorption spectrum C1 were measured, for example, using one or some of the sensing elements 31 of the detector 3, using such a spectral filter 32, the observed scattering efficiency would be approximately 50% of the peak value.

FIG. 2 also shows an example LSPR absorption spectrum C2 for gold nanorods that have been functionalized with a receptor. Once functionalized with the receptor, the extinction peak shifts to 783.6 nm. The observed scattering intensity as sampled by the filter 32 increases. FIG. 2 also shows an example LSPR absorption spectrum C3 for gold nanorods that have been functionalized with the receptor and to which a target molecule has been bound. Thus, the extinction peak of this spectrum C3 shifts further to 789.2 nm, a total shift of 5.6 nm. The observed scattering intensity also increases further to about 65%. If the resolution of the detector 3 is 16 bit, then the observable accuracy of the intensity as it changes is 1.5×10⁻⁵, when expressed in 0 to 1, per level of intensity.

It is preferred that the detector 3 only receives the response of nanoparticles that undergo binding or interaction with, for example, odor molecules. For this purpose, the spectral filter 32, in particular individual spectral filters 32, are provided over the detector 3 for the detector units 31.

In general, the LSPR absorption spectrum is dependent on the size and shape of the nanoparticles 51. Therefore, if, for example, nanorods are used as the nanoparticles 51, if there is some variation in the lengths and/or aspect ratios of the nanorods, then this will affect the LSPR absorption spectrum. However, due to the large leading side of the LSPR absorption spectrum, see, for example, the LSPR absorption spectrum C1 in FIG. 2, potential variations in size or shape of the nanoparticles 51 will not have a major impact on the system as below discussed with reference to FIG. 3.

In general, as long as the wavelength that an LSPR absorption spectrum is sampled at, for example, by the spectral filter 32, remains on one side of the LSPR absorption spectrum, preferably in a region where the LSPR absorption spectrum is fairly linear, for substantially the entire range of positions of the LSPR absorption spectrum as the refractive index adjacent the metallic nanoparticles 51, then it is possible to measure the selective binding of target molecules to the nanoparticles 51.

FIG. 3 shows the LSPR absorption spectra C4 . . . C8 of five differently sized nanoparticles 51. The nanoparticles 51 all have a width or mean diameter of 20 nm. FIG. 3 shows: an LSPR absorption spectrum C4 for nanorods having a resonance wavelength of 700 nm; the LSPR absorption spectrum C5 for nanorods having a resonance wavelength of 750 nm; the LSPR absorption spectrum C6 for nanorods having a resonance wavelength of 780 nm; the LSPR absorption spectrum C7 for nanorods having a resonance wavelength of 808 nm; and the LSPR absorption spectrum C8 for nanorods having a resonance wavelength of 850 nm. The intensity is measured at a wavelength of about 850 nm, corresponding to the transmission window 34 of the spectral filters 32, as indicated in FIG. 3.

The sensor device 1 would be able to measure the selective binding of target molecules to the nanoparticles 51 having resonance wavelengths of 750 nm, 780 nm and 808 nm because in each case the respective curve C5, C6, C7 can shift to the right leading to an increase in the observed intensity. It would also be possible to measure the selective binding of target molecules to the nanoparticles 51 having a resonance wavelength of 700 nm although the sampling at the transmission window 34 is on a part of the LSPR absorption spectrum C4 which is not very linear and, therefore, it may be more difficult to determine the response correctly. Since the wavelength at which the intensity is measured, that is, about 850 nm, coincides with the peak of the LSPR absorption spectrum C8, it would not be advantageous to measure the selective binding of target molecules to the nanoparticles 51 having a resonance wavelength of 850 nm.

Accordingly, the method employed by the sensor device 1 is robust for a size variation which results in more than a 50 nm shift in the resonance wavelength. This translates to an about 20 nm length variation of 20 nm wide gold nanorods. In turn, this is equivalent to a robustness of about 24% to 33% in size variation of the nanoparticles.

In order to obtain a fingerprint, it may be desirable to measure multiple receptors simultaneously. The detector 3 is able to measure, for example, 64 spots near simultaneously, for example, with a couple of 16 bit analogue-to-digital converters. In such a sensor device 1, most of the detector units 31, for example, 60 of them, can be used for different receptors and the remaining detector units 31, for example four detector units 31, can be used for background purposes. This may be referred to as multiplexing.

Because the sensor device 1 may wear and age, due to the receptors used, resulting in loss of sensitivity, it is desirable for the sensor device 1 to be easily replaceable. One arrangement that provides this functionality is now described with reference to FIG. 4.

FIG. 4 shows a sensor arrangement 10 which comprises the detector 3 and the sensor film 5 shown in FIG. 1 and described above. The sensor film 5, comprising the functionalized nanoparticles 51 provided on the detector 3, is mounted on a removable daughter board card 13. The removable daughter board 13 may be similar to a secure digital card, SD card for short, or a micro SD card. An advantage of the SD card size form-factor is the number of pins available for performing communications and supplying power to the detector 3. Accordingly, the daughter board 13 carrying the detector 3 and the sensor film 5 can be a replacement module 8.

The daughter board 13 provides the sensor arrangement 10 with a user interface for providing signals to the light source 2 and/or receiving signals from the detector 3.

Preferably, the sensor arrangement 10 shown in FIG. 4 provides a particularly cost effective design. For example, the micro-card format may fits into wearables. In particular, the micro-card is significantly easier to replace compared, for example, with optics such as a prism.

The sensor arrangement 10 may further comprise a housing 16 provided with a connector 14 for releasable engagement with the daughter board 13. The housing 14, shown partially cut away in FIG. 4, is provided with at least one aperture 15 to provide a flow channel 6 to allow a flow of the gas 7 through the housing 14 and past the sensor film 5 provided on the daughter board 13.

The sensor arrangement 10 may further comprise the evaluation unit 11 operable to determine a concentration of a target molecule from an intensity of the electromagnetic radiation received from a corresponding one of the, for example, two dimensional array of detector units 31.

The sensor arrangement 10 may further comprise one or more of the environmental sensors 18 operable to determine one or more ambient conditions. For example, the sensor arrangement may comprise sensors 18 operable to determine one or more of: a relative humidity, temperature and/or pressure adjacent the sensor film 5. For gas-phase applications, it may be useful to know the relative humidity, temperature and air pressure of the environment as all these variables can affect the odor molecule interaction on the nanoparticles 51. The sensors 18 may be provided in the flow channel 6 or air-duct of the sensor arrangement 10 so as to obtain accurate information regarding binding.

The air sample containing the odor molecules can be forced into the flow channel 6 by a using a pump, not shown. Alternatively, the flow 7 of gas through the housing 14 may be provided by air diffusion.

Otherwise, the same as to FIGS. 1 to 3 may also apply for FIG. 4.

In FIGS. 5 to 7, further exemplary embodiments of the sensor arrangement 10 and of the sensor device 1 are illustrated. In these embodiments, the replacement module 8 comprises different parts of the sensor arrangement 10 or of the sensor device 1. All of these examples of the various replacement modules 8 can analogously applied to all other embodiments of the sensor arrangement 10 or of the sensor device 1.

According to FIG. 5, the replacement module 8 is composed of the daughter board 13 that only carries the second polarizer 62 and the sensor film 5, wherein the second polarizer 62 serves as a support for the sensor film. Hence, the detector 3 is located on the main board 12 and does not need to be replaced.

As an option, the light source 2 can be arranged on a side of the evaluation unit 11 remote from the main board 12. The connector 14 can be located on a lateral face of the evaluation unit 11. Such an arrangement is also possible in all other exemplary embodiments.

Moreover, as a further option, in FIG. 5 it is illustrated that the light source 2 can emit the primary radiation P into a wide angular range. Therefore, there can be at least two reflecting optical elements 4, on each side of the light source 2, but also more in other lateral directions. Otherwise, there is only one reflecting optical element 4 that may surround the light source 2 in a ring-like fashion. For example, the reflecting optical elements 4 may be a reflector following or nearly following Lambert's cosine law, or also a specularly reflecting mirror.

Otherwise, the same as to FIGS. 1 to 4 may also apply for FIG. 5.

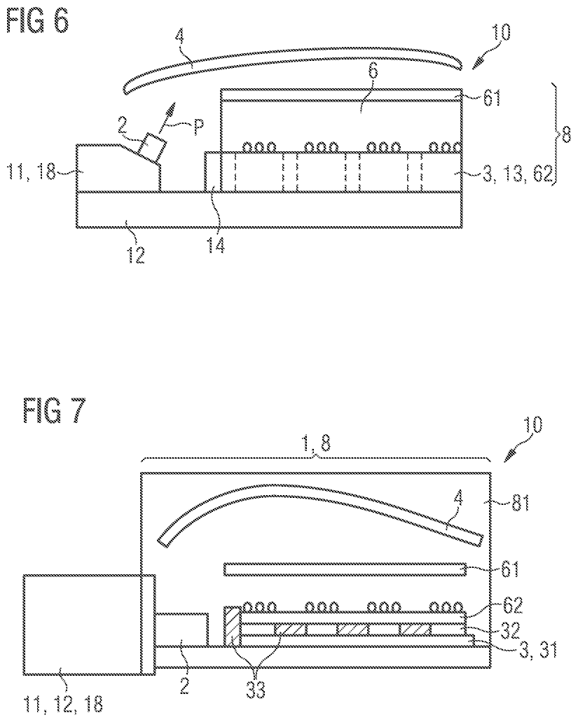

According to FIG. 6, the replacement module 8 is composed of the detector 3 as the daughter board 13 that carries also the sensor film 5 as well as the two polarizers 61, 62. Hence, the complete channel 6 for the gas 7 or the liquid to be investigated may be replaced, if required.

As an option, the light source 2 may be arranged in an oblique manner so that a direction of main emission of the primary radiation P is towards the reflecting optical element 4. This may be achieved, for example, by an accordingly shaped evaluation unit 11, main board 12 and/or environmental sensor 18, or also by additional optics near the light source 2, not shown in FIG. 6. Such an alignment of the direction of main emission of the primary radiation P can also be present in all other exemplary embodiments.

Moreover, in FIG. 6 it is illustrated that the nanoparticles 51 can be arranged only on top of the respective detector units 31 so that regions between adjacent detector units 31 are free of the nanoparticles 51. Hence, optical cross-talk can be reduced. All the different regions having the nanoparticles 51 can be provided with the same nanoparticles 51 and/or spectral filters 32, or there are various types of nanoparticles 51 and/or spectral filters 32. These aspects may also apply for the other exemplary embodiments.

Otherwise, the same as to FIGS. 1 to 5 may also apply for FIG. 6.

According to FIG. 7, the replacement module 8 is composed of all the components from the detector 3 to the reflecting optical element 4, wherein the daughter board 13 may serve as a common carrier. As an option, the light source 2 as well may be arranged on the replacement module 8. By means of this set-up, the sensor arrangement 10 can easily be adapted to various measurement scenarios. For all these components, there can be a common module housing 81 of, for example, a plastic material or a metal.

Moreover, between adjacent regions with nanoparticles 51 and/or between adjacent detector units 31, there can be the optical insulations 33. These optical insulations 33 may be of a reflective material, like a metal, or may be of an absorbing material, like carbon black. Such an arrangement is also possible in all other exemplary embodiments.

Otherwise, the same as to FIGS. 1 to 6 may also apply for FIG. 7.

In FIG. 8, an exemplary embodiment of the nanoparticles 51 is illustrated. The nanoparticle 51 comprises a core 53 of a metal like gold. Around the core 53, there is a shell 52. The shell is, for example, of an organic material like the receptor or bio-receptor to enable binding of the analyte to the nanoparticle 51. The Shell 52 may be a monolayer of receptor molecules.

The nanoparticle 51 shown in FIG. 8 is of spherical shape, but the core-shell set-up is preferably present in all other exemplary embodiments.

In FIG. 9 it is shown that the nanoparticle 51 is of rod-shape or cylinder shape. Preferably, the nanoparticle 51 has edges at its ends, and no round ends. According to FIG. 10, the nanoparticle 51 is of bi-pyramidal shape. For example, the nanoparticle 51 is composed in a symmetric manner by two pyramids having a square base. Such nanoparticles 51 can be used in all exemplary embodiments, also in combination.

An aspect ratio of a length W1 and a diameter W2 of the nanoparticle 51 is preferably around 4:1, for example, between 2.5 and 5 inclusive. The diameter W2 may refer to an edge length of the square base in case of nanoparticles 51 of pyramidal or bi-pyramidal shape.

For example, referring to nanoparticles 51 of bi-pyramidal shape, W1 is 27 nm and W2 is 19 nm, or W1 is 50 nm and W2 is 18 nm, or W1 is 103 nm and W2 is 26 nm, or W1 is 189 nm and W2 is 40 nm. Referring to nanoparticles 51 of cylindrical shape, W1 may be 40 nm and W2 may be 17 nm, or W1 may be 55 nm and W2 may be 16 nm, or W1 may be 74 nm and W2 may be 17 nm. All the mentioned dimensions W1, W2 may apply with a tolerance of at most a factor of 1.5 or of at most a factor of 1.25.

In FIG. 11, a further exemplary embodiment of the sensor device 1 is shown. Contrary to the previous exemplary embodiments, there is no reflecting optical element, but the light source 2 is directly located above the sensor film 5. Thus, compared with the previous embodiments, the combination of reflecting optical element and light source is replaced in FIG. 11 by the light source 2 only, wherein the light source 2 may be located in the place of the reflecting optical element of the previous exemplary embodiments. Hence, in top view of the sensor film 5, the light source 2 is located on the sensor film 5, for example, symmetrically and/or centrally.

The light-source 2 could be located in a roof of an SD card holder or an SD card housing. Hence, in particular the sensor film 5 and optionally the detector 3 and/or the polarizers could be disposable parts integrated in a SD card and located on a daughter board instead of the main board illustrated in FIG. 11. Hence, like, for example, in FIGS. 5 to 7, the sensor film 5 and optionally the polarizers 61, 62, the detector 3 as well as the light source 2 itself may be arranged in a replacement module.

Accordingly, a main emission direction M of the light source 2 may be oriented perpendicular to the sensor film 5. As an option, there can be light source optics 21 like a fast axis lens, in order to achieve homogeneous illumination of the sensor film 5. The light source optics 21 preferably has no or no significant influence on the main emission direction M and may be included in a housing of the light source 2, not shown. That is, the light source optics 21 may be located close to the light source 2, and the light source optics 21 and the light source 2 could be on the same side of the first polarizer 61.

The light source optics 21 and the sensor film 5 may have the same or about the same width. For example, the widths of the sensor film 5 and of the light source optics 21 deviate from each other by at most a factor of 1.2 or by at most a factor of 1.5.

For example, the light source 2 is an LED, a laser diode like a VCSEL with or without a small condenser lens, for example, on a flex foil of a printed circuit board. Further, the light source 2 may be an organic LED so that the light source 2 could have a large light-emission area, and the light source optics 21 may be omitted.

The detector 3 may be arranged on the main board 12 or on the daughter board and may contain or carry the evaluation unit 11 and the optional environmental sensor 18.

Otherwise, the same as to FIGS. 1 to 10 may also apply for FIG. 11.

In the embodiment of FIG. 12, the light source 2 is not directly above the sensor film 5, but indirectly, so that still the main emission direction M of the light source 2 may directly point to the sensor film 5. In this case, the optional light source optics 21 could be a prism or an optical system comprising a prism and a lens. In addition, the light source optics 21 may also include a reflecting optical element, not illustrated in FIG. 12.

Otherwise, the same as to FIG. 11 may also apply for FIG. 12.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

This patent application claims the priority of German patent application 102021103211.3, the disclosure content of which is hereby incorporated by reference.

### LIST OF REFERENCE SIGNS

1 sensor device
2 light source
21 light source optics
3 semiconductor detector
30 top side
31 detector unit
32 spectral filter
33 optical insulation
34 transmission window
4 reflecting optical element
5 sensor film
51 metallic nanoparticle
52 shell
53 core
6 channel
61 first polarizer
62 second polarizer
7 liquid or gas
8 replacement module
81 module housing
10 sensor arrangement
11 evaluation unit
12 main board
13 daughter board
14 connector
15 aperture
16 housing
18 environmental sensor
C. curve
D distance sensor film—first polarizer
E optical extinction
H height reflecting optical element—top side
L wavelength in nm
M main emission direction of the light source
P primary radiation
S secondary radiation
W1 length of the nanoparticle
W2 diameter of the nanoparticle

1. A sensor device comprising:
a light source configured to emit a primary radiation,
a detector comprising a plurality of detector units,
a reflecting optical element arranged optically between the light source and the detector, and
a sensor film comprising metallic nanoparticles geometrically between the reflecting optical element and the detector,
wherein
the sensor film is configured to be exposed to a liquid or gas, and
the detector is configured to detect a spectral change in the primary radiation (P) caused by the sensor film upon exposure to the liquid or gas,
the reflecting optical element is a parabolic mirror, the reflecting optical element is the only reflective optics in a beam path between the light source and the detector, and
the detector is configured to detect secondary radiation scattered by the metallic nanoparticles, and
the primary radiation from the light source scattered at the metallic nanoparticles is measured in a transmission configuration.

2. The sensor device according to claim 1, wherein the primary radiation from the light source arrives at the detector only upon reflection at the reflecting optical element so that at least 99% of radiation arriving at the detector has been reflected at the reflecting optical element.

3. The sensor device according to claim 1, wherein all of the sensor film is located geometrically between the reflecting optical element and the detector.

4. The sensor device according to claim 1, wherein the light source is located directly above the sensor film, seen in top view of the sensor film, and a main emission direction of the light source points directly to the sensor film.

5. The sensor device according to claim 1, wherein at least some of the detector units are assigned to different kinds of metallic nanoparticles, the different kinds of metallic nanoparticles comprise different receptor shells, so that the detector is sensitive to at least one constituent of the liquid or gas.

6. The sensor device according to claim 1, further comprising spectral filters assigned to the detector units, wherein the spectral filters each have a spectral transmission window with a full width at half maximum of at most 10 nm.

7. The sensor device according to claim 6, wherein the transmission windows are each located on a long-wavelength wing of extinction spectra of the metallic nanoparticles.

8. The sensor device according to claim 1, further including a pair of polarizers comprising a first polarizer and a second polarizer, wherein the sensor film is arranged between the first polarizer and the second polarizer, and wherein the first polarizer is located between the light source and the sensor film.

9. The sensor device according to claim 1, wherein, seen in top view of the detector, the metallic nanoparticles are applied only atop the detector units so that an intermediate space between adjacent detector units is free of the metallic nanoparticles.

10. The sensor device according to claim 1, wherein, seen in top view of the detector units, an area proportion of the respective detector unit covered by the assigned metallic nanoparticles is at least 0.01 and at most 0.2 of an overall area of the respective detector unit.

11. The sensor device according to claim 1, wherein the metallic nanoparticles are of bi-pyramidal shape having an aspect ratio of a mean length to a mean width of at least 2 and of at most 8, wherein the mean length is at least 0.04 μm and at most 0.5 and wherein at least 90% of the metallic nanoparticles have a length of at least 0.7 times and of at most 1.5 times the mean length.

12. The sensor device according to claim 1, wherein
the detector is a semiconductor detector.

13. A sensor arrangement comprising:
at least one sensor device according to claim 1, and
an evaluation unit configured to evaluate a signal from the detector.

14. The sensor arrangement according to claim 13, wherein the evaluation unit is on a main board and at least the sensor film is located on a separate daughter board.

15. The sensor arrangement according to claim 14, wherein the main board and the daughter board are electrically connected by a connector, a connection direction runs in parallel with the main board and the daughter board.

16. The sensor device according to claim 1, wherein
the light source is a light-emitting diode or a semiconductor laser.

17. The sensor device according to claim 1, wherein
the primary radiation has a peak wavelength of at least 750 nm and of at most 1.2 μm.

18. The sensor device according to claim 1, wherein
the metallic nanoparticles are of gold.

19. A sensor device comprising:
a light source configured to emit a primary radiation,
a detector comprising a plurality of detector units,
a reflecting optical element arranged optically between the light source and the detector, and
a sensor film comprising metallic nanoparticles geometrically between the reflecting optical element and the detector,
wherein
the sensor film is configured to be exposed to a liquid or gas,
the detector is configured to detect a spectral change in the primary radiation caused by the sensor film upon exposure to the liquid or gas,
the reflecting optical element is a parabolic mirror, the reflecting optical element is the only reflective optics in a beam path between the light source and the detector, and
the detector is configured to detect secondary radiation scattered by the metallic nanoparticles.
